(19) United States
(12) Patent Application Publication
(10) Pub. No.: US 2005/0066769 A1
(43) Pub. Date: Mar. 31, 2005

(54) Wave gear device

(75) Inventor: Yoshihide Kiyosawa, Nagano-ken (JP)

Correspondence Address: BURNS DOANE SWECKER & MATHIS L L P, POST OFFICE BOX 1404, ALEXANDRIA, VA, 22313-1404, US

(73) Assignee: Harmonic Drive Systems Inc., Tokyo (JP)

(21) Appl. No.: 10/885,102

(22) Filed: Jul. 7, 2004

(30) Foreign Application Priority Data
Jul. 18, 2003 (JP) 2003-276612

(51) Int. Cl. F16H 37/00

(52) U.S. Cl. 74/640

(57) ABSTRACT

A wave gear device has a rigid internal gear, a flexible external gear, and a wave generator. The tooth profiles of both gears are initially defined by a basic rack tooth profile shape. The lower parts of the dedendum portions of these tooth profiles are modified by curves C2 and C3 having pressure angles α2 and α3 that are less than the standard pressure angle α1 of the basic rack tooth profile shape C1. An increase in thickness of the tooth bottom side can be minimized even if the tooth depth is increased and the tooth thickness/tooth space ratio changed to increase the tooth thickness. Hence, the ratcheting torque of a wave gear device having a high reduction gear ratio can be increased without reducing the service life and strength of a pinion cutter for the rigid internal gear, or the fatigue strength of the flexible external gear.

### BACKGROUND OF THE INVENTION

1. Field of the Invention

The present invention relates to a wave gear device with a high reduction gear ratio, and more particularly to a wave gear device with a high tooth-depth tooth profile that is advantageous for increasing ratcheting torque.

2. Description of the Related Art

Since it was proposed in JP-B 45-41171 that an involute tooth profile could be used for a wave gear device, an easy-to-cut basic rack tooth profile (involute tooth profile) has been widely adopted as the basic tooth profile of the gears constituting the wave gear device. Examples of the basic rack tooth profile adopted for an circular rigid internal gear and a flexible external gear of a wave gear device are indicated as a “conventional C/S tooth profile” and a “conventional F/S tooth profile” in FIG. 3, and these are shown with broken lines. It is apparent from this diagram that in the basic rack tooth profile the pressure angle increases from the portion defining the tooth engagement area toward the tooth bottom and the tooth tip.

The tooth module is smaller in a wave gear device with a high reduction gear ratio, and the tooth depth becomes small corresponding to the value of the module, so that the ratcheting torque is also reduced. In order to realize a wave gear device having a high reduction gear ratio without sacrificing the ratcheting torque, it is possible to consider adopting an elongated tooth profile for securing a sufficient tooth depth. However, such a pinion cutter that has a tooth profile with a pointed tooth tip portion must be used for the rigid internal gear to have the elongated tooth profile. This causes to deteriorate the service life and strength of the pinion cutter.

As a solution thereto, it is possible to consider changing the ratio of the tooth thickness and tooth space in the tooth profile of both gears so as to increase the tooth thickness. However, when the tooth thickness is increased, bending stress is concentrated on the dedendum portion, and the fatigue strength of the flexible external gear is greatly degraded.

### SUMMARY OF THE INVENTION

An object of the present invention is to provide a tooth profile shape for a wave gear device whereby the ratcheting torque of the wave gear device having a high reduction gear ratio can be increased without deteriorating the service life or strength of a pinion cutter for a rigid internal gear or degrading the fatigue strength of a flexible external gear.

In order to solve the above and other problems, a wave gear device according to the present invention has:

a circular rigid internal gear,

a flexible external gear coaxially disposed inside the rigid internal gear,

a wave generator for flexing the flexible external gear in a radial direction to create partial engagement with the rigid internal gear, and for moving engagement positions of both gears in a circumferential direction; wherein

tooth profile shapes of the rigid internal gear and the flexible external gear are initially defined based on a basic rack tooth profile curve, and

a shape of a dedendum portion in the tooth profile of at least one of the gears is modified so that the shape has a pressure angle that is less than a standard pressure angle of the basic rack tooth profile.

The present invention is also directed to a rigid internal gear for a wave gear device, wherein a tooth profile shape is initially defined based on a basic rack tooth profile curve, and a shape of a dedendum portion thereof is modified so that the shape has a pressure angle that is less than a standard pressure angle.

Furthermore, the present invention relates to a flexible external gear for a wave gear device, wherein a tooth profile shape is initially defined based on the basic rack tooth profile curve, and a shape of a dedendum portion thereof is modified so that the shape has a pressure angle that is less than a standard pressure angle.

In the rigid internal gear and/or the flexible external gear of the wave gear device of the present invention, the tooth profiles thereof are defined based on the basic rack tooth profile, and each tooth profile shape of the dedendum portion thereof is modified so that the pressure angle on the dedendum portion is less than the standard pressure angle. Setting the tooth profile shape in this manner allows an increase in the thickness of the tooth bottom side portion to be kept small when the tooth depth thereof is increased in order to increase the ratcheting torque, and the tooth thickness thereof is increased in order to prevent degradation of the service life and strength of the pinion cutter. As a result, the concentration of stress in the tooth bottom portion can be alleviated, and degradation of the fatigue strength of the flexible external gear can be prevented.

Consequently, in accordance with the present invention, a high tooth-depth tooth profile can be adopted as the tooth profile of a wave gear device having a high reduction gear ratio without reducing the service life and strength of a pinion cutter for the rigid internal gear, or the fatigue strength of the flexible external gear. The ratcheting torque of a wave gear device having a high reduction gear ratio can be thereby increased.

### BRIEF DESCRIPTION OF THE DRAWINGS

FIG. 1 is a cross-sectional view of a wave gear device according to the present invention;

FIG. 2 is a schematic diagram showing the engaged state of both gears of the wave gear device in FIG. 1; and

FIG. 3 is a schematic diagram showing the tooth profile of the present invention and a conventional basic rack tooth profile.

### DESCRIPTION OF THE PREFERRED EMBODIMENTS

An embodiment of a wave gear device according to the present invention will be described with reference to the drawings.

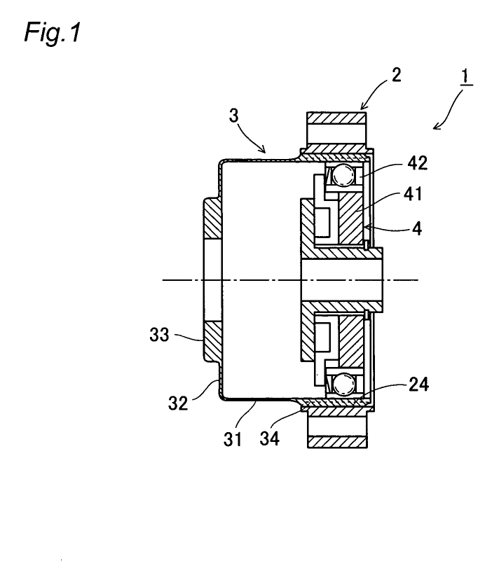

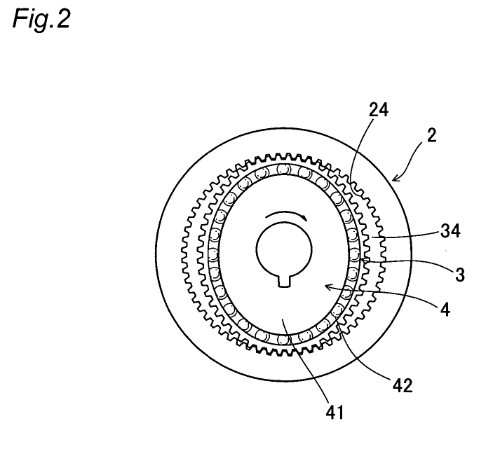

FIG. 1 is a cross-sectional view of a wave gear device, and FIG. 2 is a schematic diagram showing gears of the wave gear device in an engaged state. A wave gear device 1 comprises a circular rigid internal gear 2, a flexible external gear 3 coaxially disposed therein, and a wave generator 4 fitted therein. The flexible external gear 3 is of a cup shape having a cylindrical body portion 31, an annular diaphragm 32 extending radially and inwardly from one end of the body portion 31, and a discoid boss 33 formed in a continuous fashion on an internal peripheral edge of the annular diaphragm 32. External teeth 34 are formed on an external peripheral surface portion of an open end side of the body portion 31.

The wave generator 4 comprises an elliptically contoured rigid cam 41, and a wave bearing 42 having flexible inner and outer races. The inner race is fitted on an external peripheral surface of the rigid cam 41. The open end side portion of the body portion 31 of the flexible external gear 3 is elliptically flexed by the wave generator 4, as shown in FIG. 2, and portions positioned at both ends in the direction of a major axis of an ellipse in the external teeth 34 engage internal teeth 24 of the rigid internal gear 2.

The rigid internal gear 2 is commonly fixed to a fixed side member (not depicted), and the wave generator 4 is rotationally driven by a motor or the like. As the wave generator 4 rotates, the engaged positions of both gears 2 and 3 move in a circumferential direction. The tooth number difference of the two gears is set to be 2n (where n is a positive integer), and a relative rotation, the speed of which is considerably reduced with respect to that of the rotation of the wave generator 4, is generated between both gears according to the difference in number of teeth. The rigid internal gear 2 is fixed, so that the flexible external gear 3 rotates and the rotation is transmitted to a load side (not depicted) connected thereto.

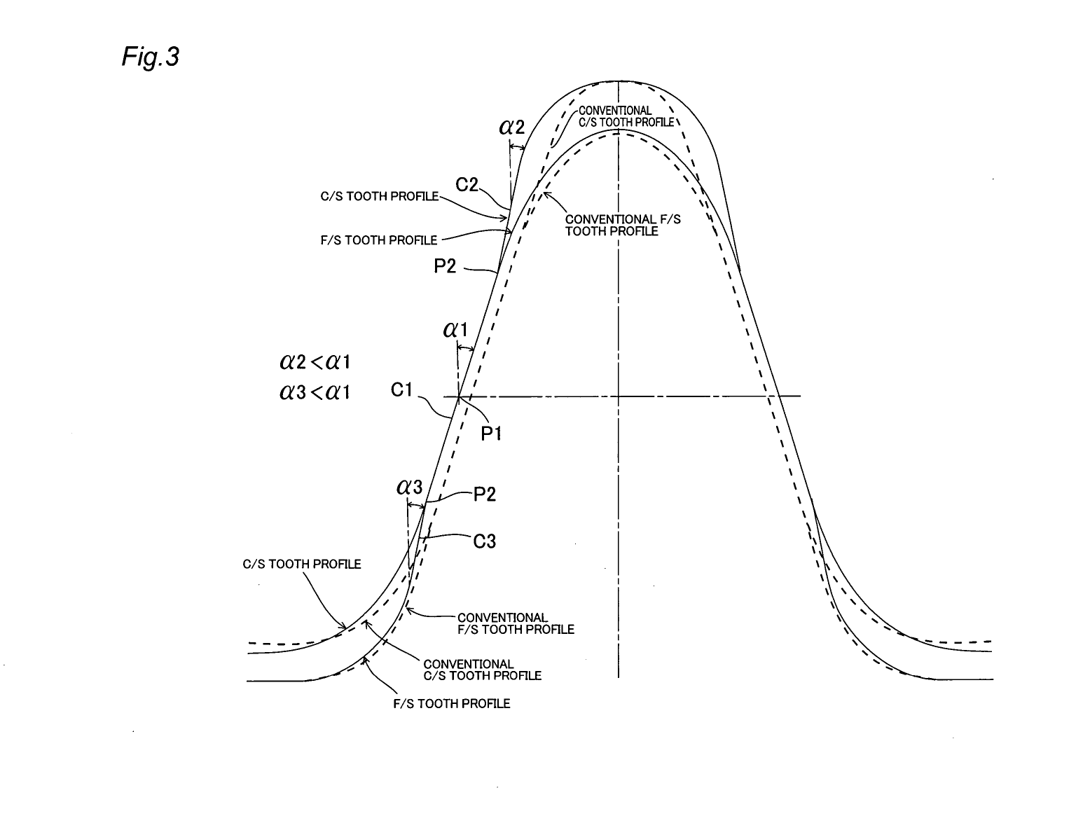

In FIG. 3, the tooth profile shapes (indicated as “C/S tooth profile” and “F/S tooth profile”) of the external teeth 34 of the flexible external gear 3 and the internal teeth 24 of the rigid internal gear 2 are shown with a solid line. The tooth profile shapes are initially defined based on a basic rack tooth profile curve C1, and the standard pressure angle at the reference pitch lines thereof is α1. The tooth profile shape of the rigid internal gear 2 is partially modified by a curve C2 so that a lower half part of the dedendum flank in the basic rack tooth profile curve C1 becomes a pressure angle α2, which is less than the standard pressure angle α1. The curves C1 and C2 are smoothly connected with each other at a point P2.

The tooth profile shape of the flexible external gear 3 has a substantially rotationally symmetric form with respect to a pitch point P1. Namely, it is basically defined by the basic rack tooth profile curve C1 and is modified by a curve C3 on a lower half part of the ddendum flank, and these curves C1 and C3 are smoothly connected with each other at a point P3. A pressure angle α3 on the curve C3 is less than the standard pressure angle α1.

Thus, the tooth profile shapes of both gears 2 and 3 are such that the pressure angles on the lower half portions of the dedendum flanks thereof are less than the standard pressure angle α1. Therefore, an increase in thickness of the tooth bottom side can be prevented even if the tooth depth is increased and the ratio of tooth thickness and tooth space is changed to increase the tooth thickness.

The above-described example is one in which the present invention has been applied to a wave gear device comprising a cup-shaped flexible external gear. The present invention may also be applied in the same manner to one in which the flexible external gear has a silk hat shape or an annular shape.

1. A wave gear device having:
a circular rigid internal gear,
a flexible external gear coaxially disposed inside the rigid internal gear,
a wave generator for flexing the flexible external gear in a radial direction to create partial engagement with the rigid internal gear, and for moving engagement positions of both gears in a circumferential direction; wherein
tooth profile shapes of the rigid internal gear and the flexible external gear are basically defined by a basic rack tooth profile curve, and
a shape of a lower part of a dedendum portion of the tooth profile of at least one of the gears is modified so that the shape has a pressure angle that is less than a standard pressure angle of the basic rack tooth profile curve.

2. A rigid internal gear of the wave gear device according to claim 1, wherein
a tooth profile shape thereof is basically defined by a basic rack tooth profile curve, and
a shape of a lower part of a dedendum portion thereof is modified so that the shape has a pressure angle that is less than a standard pressure angle.

3. A flexible external gear of the wave gear device according to claim 1, wherein
a tooth profile shape thereof is basically defined by a basic rack tooth profile curve, and
a shape of a lower part of a dedendum portion thereof is modified so that the shape has a pressure angle that is less than a standard pressure angle.
